(19) United States
(12) Patent Application Publication
(10) Pub. No.: US 2013/0024255 A1
(43) Pub. Date: Jan. 24, 2013

(54) SYSTEMS AND METHODS FOR ENABLING A CLIENT TO ACQUIRE A COMMODITY VIA A SURVEY

(71) Applicants: Eric Clark MITTEREDER, Washington, DC (US); Joseph John PETERS, Rochester, NY (US)

(72) Inventors: Eric Clark MITTEREDER, Washington, DC (US); Joseph John PETERS, Rochester, NY (US)

(73) Assignee: APPINION LLC, New York, NY (US)

(21) Appl. No.: 13/185,249

(22) Filed: Jul. 18, 2011

(51) Int. Cl. G06Q 30/00

(52) U.S. Cl. 705/14.17; 705/14.19

(57) ABSTRACT

Systems, methods, and computer program products for enabling a client to acquire a commodity via a survey are provided. One system includes a processor and memory coupled to the processor. The memory is configured to store instructions that, when executed by the processor, cause the processor to provide a survey to a client, receive the survey completed by the client, and enable the client to utilize completion of the survey to acquire a commodity. A method includes providing a survey to a client, receiving the completed survey, and enabling the client to utilize completion of the survey to acquire a commodity. One computer program product includes a computer-readable medium configured to store instructions that, when executed by a processor, cause the processor to perform a method for enabling a client to acquire a commodity via a survey. The computer program product includes computer code for performing the above method.

### BACKGROUND OF THE INVENTION

1. Field of the Invention

The present invention relates generally to computing systems, and more particularly to, systems, methods, and computer program products for enabling a client to acquire a commodity via a survey.

2. Description of the Related Art

The ability to acquire goods and services via the Internet has been available since the beginning of the Internet. Typically, when a consumer decides to acquire a commodity (e.g., a data file, a music file, a game file, a digital file (e.g., an ebook, an emagazine, a movie, and the like) an application file, a good, a service, etc.) via the Internet, the consumer logs in to a user account and presents a monetary instrument (e.g. a debit card, credit card, checking account, saving account, etc.) as payment. In the vast majority of situations, the medium of exchange is money. Here, persons that do not have access to monetary funds are typically not capable of purchasing commodities via the Internet.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of one embodiment of a system for enabling a client to acquire a commodity via a survey;

FIG. 2 is a flow diagram of one embodiment of a method for enabling a client to acquire a commodity via a survey;

FIG. 3 is a flow diagram of another embodiment of a method for enabling a client to acquire a commodity via a survey; and

FIG. 4 is a flow diagram of yet another embodiment of a method for enabling a client to acquire a commodity via a survey.

### DETAILED DESCRIPTION OF THE DRAWINGS

The illustrated embodiments below provide systems and methods for enabling a client to acquire a commodity via a survey. Also provided are computer program products for enabling a client to acquire a commodity via a survey.

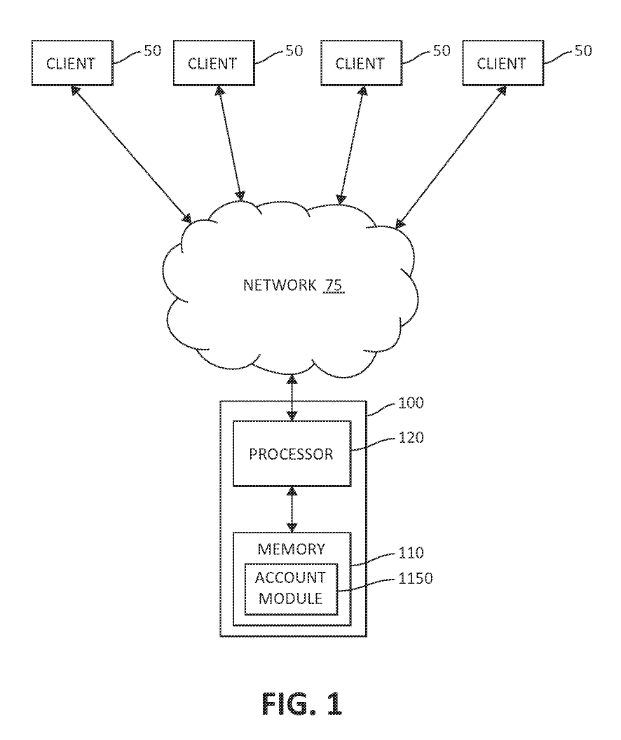

Turning now to the figures, FIG. 1 is a block diagram of one embodiment of a system 100 (e.g., a server) for enabling a client to acquire a commodity via a survey. As used herein, the term “survey” may include, but is not limited to a questionnaire comprising one or more questions, queries, tasks, and/or user inputs. As illustrated in FIG. 1, system 100 is coupled to and in communication with one or more clients 50 (e.g., one or more consumers) via a network 75 (e.g., a large area network (LAN), wide area network (WAN), the Internet, and/or the like networks). Furthermore, at least in the illustrated embodiment, system 100 comprises a memory 110 including an acquisition module 1150 and is coupled to a processor 120.

Client(s) 50 may be any type of computing device known in the art or developed in the future capable of enabling a user to communicate with system 100 as described below. Examples of clients 50 include, but are not limited to, desktop computing devices, laptop and notebook computing devices, netbook computing devices, telephony devices (e.g. cellular telephones, smart phones, etc.), MP3 players, computing tablets, televisions, and the like computing devices.

Memory 110 may be any type of memory known in the art or developed in the future capable of storing acquisition module 1150, one or more surveys, and one or more commodities available for acquisition by a user. Acquisition module 1150, in one embodiment, comprises computer code that, when executed by processor 120, causes processor 120 to perform a method for enabling clients 50 to acquire a commodity (e.g., a data file, a music file, a game file, an application file, a digital file (e.g., an ebook, an emagazine, a movie, and the like), a good, a service, etc.).

Processor 120 may be any processor known in the art or developed in the future capable of executing the instructions included within the computer code that comprises acquisition module 1150. When executing the instructions in acquisition module 1150, processor 120 is configured to enable clients 50 to create and edit a user account that includes a user profile and an amount of credits available to the user for purchasing commodities.

In one embodiment, the user profile includes personal data relating the client and/or the user's personal preferences. The personal data may include, but is not limited to, age or age range, gender, education level and alumnus, income or income level, friends and acquaintances, colleagues, occupation and former occupations, marital status, political preference, religious preference, number of children or dependents, geographic location (e.g., city, county, state, country, zip code, etc.), and the like personal data. A user's personal preferences may include, but are not limited to, computing device preferences, brand preferences, company preferences, type of company preferences (e.g., environmentally friendly, fair trade, no animal testing, etc.), fashion preferences, music preferences, print media preferences, hygiene product preferences, television preferences, motion picture preferences, Internet preferences, food preferences, drink preferences, entertainment preferences, sports preferences, hobby preferences, travel, transportation preferences (e.g., automobile, motorcycle, air travel train, subway, etc.), automobile preferences, motorcycle preferences, household goods preferences, exercise preferences, diet preferences, and the like personal preferences.

In various embodiments, processor 120 is configured to receive a request from a user (via client 50) to transmit a survey to client 50 after the user has logged in to his/her user account. Processor 120 is configured to then transmit a survey stored in memory 110 to the requesting client 50 in response thereto.

In one embodiment, processor 120 is configured to determine what, if any, surveys this particular user has completed and determines if there are any surveys available that the user has not completed. If the user has completed all of the available surveys, processor 120 is configured to notify the user (e.g., via push notification, message through social media network and/or website, email, text message, voicemail, pop-up message, instant message, etc.) that there are no available surveys. If there are one or more surveys that the user has not completed, processor 120 is configured to transmit one or more of the surveys that the user has not completed to client 50.

In another embodiment, processor 120 is configured to determine if there are any surveys available for a particular user based on data in the particular user's profile and/or personal preferences. For example, processor 120 is configured to gather data from the particular user's profile and/or personal preferences and determine if there is a survey directed to a user including one or more criteria matching the particular user's personal data and/or personal preferences and transmit such survey to the user via client 50 and/or notify the user (e.g., via push notification, message through social media network and/or website, email, text message, voicemail, pop-up message, instant message, etc.). For example, processor 120, after gathering data in the user's personal data and personal preferences may determine that this particular user is a female with a household income greater than $100,000 who likes sports cars and that there is a survey directed to females who have a household income greater than $50,000 and that are interested in automobiles. In response thereto, processor 120 is configured to transmit this survey and/or “push” notify this particular user.

Processor 120 is further configured to receive the completed survey from client 50 after the user has completed the survey. In doing such, processor 120 is configured to determine if the user has properly completed the survey (e.g., answered all of the queries, completed all of the fields, etc.). If processor 120 determines that the survey is incomplete, processor 120 is configured to notify the user, return the survey to the user, and/or otherwise enable the user to properly complete the survey. If the survey is properly completed, processor 120 is configured to increment the number of credits in the user's credit account.

In one embodiment, processor 120 is configured to increment the user's credit account by the same number of credits for each properly completed survey. For example, each time a user properly completes a survey, the user's credit account is incremented a predetermined number of credits (e.g., one, two, three, etc.).

In other embodiments, processor 120 is configured to increment the user's credit account by a differing number of credits for each properly completed survey depending on various characteristics of the survey. For example, a relatively short survey may be worth one credit, whereas a longer survey may be worth two or three credits. Likewise, a relatively easy survey may be worth one credit, whereas a more complex survey may be worth two or three credits. In another example, a user may receive more credits for completing a survey that is targeted to that particular user than the same user receives for completing a survey that is generally available.

In yet other embodiments, processor 120 is configured to increment the user's credit account by a differing number of credits for each properly completed survey depending on various characteristics in the user's profile, personal preferences, and/or contacts/friends. For example, a user with a user profile and/or personal preferences that include(s) a greater amount of data/information may receive more credits for completing the same survey than a user with a user profile and/or personal preferences that include(s) a lesser amount of data/information. In another example, a user with a greater number of contacts/friends may receive more credits for completing the same survey than a user with a lesser number of contacts/friends. That is, the user's profile may be linked to one or more social media networks and/or websites and the data included in the linked social media network(s) and/or website(s) may be utilized to increase the user's ability to earn credits via their contacts/friends on the social media network(s) and/or website(s).

In still other embodiments, processor 120 is configured to increment the user's credit account by a differing number of credits based on the user's activity and/or usage. For example, a user that frequently completes surveys may receive a greater number of credits than users that infrequently complete surveys.

In an alternative embodiment, processor 120 is configured to increment the user's credit account by a differing number of credits based on a status level of the user. The status may be based on usage, upgrading a membership level, recruiting, user profile, personal preferences, gender, education level and alumnus, income or income level, friends and acquaintances, colleagues, occupation and former occupations, political preference, number of children or dependents, geographic location, and the like. For example, a user with a gold status may receive more credits for completing a survey than a user with a silver status receives for completing the same survey.

As used herein, the terms “type of survey” include, but is not limited to, various characteristics (e.g., length, complexity, etc.) of the survey, the target (e.g., users with specific characteristics in their user profile, user with specific personal preferences, user with a predetermined number of contacts/friends, etc.) of the survey, and the origin or source (e.g., a company, a brand, a political party, a government entity, etc.) of the survey. That is, a “type of survey” may include any feature and/or characteristic that distinguishes between survey, targets of the survey, and/or recipients of the survey.

Processor 120 is further configured to present to users (via clients 50) one or more commodities (e.g., a data file, a music file, a game file, a digital file (e.g., an ebook, an emagazine, a movie, and the like), an application file, a good, a service, etc.) that the users are able to acquire utilizing the credits in their respective credit accounts. That is, processor 120 is configured to present one or more commodities to users and include the amount of credits needed to acquire each commodity.

Furthermore, processor 120 is configured to receive requests from users to utilize their credits to acquire one or more commodities. That is, each user is able to use his/her credits to acquire a commodity provided that the user has the needed amount of credits in his/her credit account. If the user does not have enough credits in his/her credit account, processor 120 is configured to decline the request to acquire the commodity. If the user has sufficient credits in his/her account, processor 120 is configured to transfer or otherwise provide the commodity to the user. In addition, processor 120 is configured to decrement the user's credit account the number of credits needed to acquire the commodity.

In various other embodiments, processor 120 is configured to present one or more commodities to a user. Processor 120 is then configured to receive a selection of one or more of the presented commodities from the user. In response thereto, processor 120 is configured to transmit a survey to the user. Processor 120 is further configured to receive the completed survey and determine if the survey is properly completed. If processor 120 determines that the survey is incomplete, processor 120 is configured to notify the user, return the survey to the user, and/or otherwise enable the user to properly complete the survey. If the survey is properly completed, processor 120 is configured to transmit or otherwise provide the selected commodity to the user.

In one embodiment, the survey that is transmitted to the user is directly tied to the commodity selected by the user. For example, if the commodity the user selects is a game targeted for teenagers, the survey may ask the opinion of the user with regards to teen fashion, energy drinks, motion pictures, television programming, teen hygiene products, game platforms, music, actor/actress preferences, and/or the like categories that are appropriately targeted for teenagers.

In another embodiment, the survey that is transmitted to the user is randomly selected. In randomly selecting a survey, any known or developed method of randomly selecting a survey may be utilized.

In yet another embodiment, the survey that is transmitted to the user is directly tied to one or more characteristics of the user. For example, if the user is a 32 year-old-male professional, the transmitted survey may ask the user's opinion with regards to politics, fashion, automobile preferences, investing, and/or the like questions that are appropriate for this demographic.

The following examples may be helpful in better understanding the various embodiments presented herein. As one skilled in the art will recognize, the spirit and scope of the various embodiments presented herein is not limited by the following examples.

In one example, after a user logs in to his/her user profile, the user, via a client 50, can search through a plurality of available surveys to determine a survey that the user would like to complete. The user is then able to select a survey and request that system 100 (i.e., processor 120) transmit the selected survey to the user. Upon receipt of the request, system 100 will then transmit the selected survey to the user. The user completes the survey and returns the survey to system 100 (i.e., processor 120). After determining that the survey is complete, processor 120 determines the amount of credits the survey is worth and increments the user's credit account by the appropriate amount. The user may then desire to acquire a commodity and transmits a request to processor 120 to acquire the commodity. Upon receipt of the request, processor 120 determines the amount of credits needed to acquire the commodity and whether the user has sufficient credits in his/her credit account to acquire the commodity. After determining that the user has sufficient credits in his/her credit account, processor 120 transmits the commodity or otherwise provides the commodity to the user.

In another example, processor 120 receives a request from a user, via client 50, to receive a survey. Processor 120 will then gather data from the user's personal profile and/or personal preferences and select an appropriate survey based on one or more characteristics in the user's personal profile and/or personal preferences. Processor 120 will then transmit the selected survey to the user. After receiving the survey and determining that the survey is complete, processor 120 determines the amount of credits the survey is worth and increments the user's credit account by the appropriate amount. The user may then desire to acquire a commodity and transmits a request to processor 120 to acquire the commodity. Upon receipt of the request, processor 120 determines the amount of credits needed to acquire the commodity and whether the user has sufficient credits in his/her credit account to acquire the commodity. After determining that the user has sufficient credits in his/her credit account, processor 120 transmits the commodity or otherwise provides the commodity to the user.

In yet another example, after a user logs in to his/her user profile, the user, via a client 50, can search through a plurality of commodities that the user may desire to acquire. The user then transmits a request to system 100 (i.e., processor 120) that the user desires to acquire a particular commodity. Upon receipt of the request, system 100 will then transmit a survey tied to the particular commodity to the user. The user completes the survey and returns the survey to system 100 (i.e., processor 120). After determining that the survey is complete, processor 120 transmits the particular commodity or otherwise provides the particular commodity to the user.

In still another example, after a user logs in to his/her user profile, the user, via a client 50, can search through a plurality of commodities that the user may desire to acquire. The user then transmits a request to system 100 (i.e., processor 120) that the user desires to acquire a particular commodity. Upon receipt of the request, system 100 will then gather data from the user's personal profile and/or the user's personal preferences transmit a survey related to the user's personal profile and/or the user's personal preferences to the user. The user completes the survey and returns the survey to system 100 (i.e., processor 120). After determining that the survey is complete, processor 120 transmits the particular commodity or otherwise provides the particular commodity to the user.

In still yet another example, after a user logs in to his/her user profile, the user, via a client 50, can search through a plurality of available surveys to determine a survey that the user would like to complete. The user is then able to select a survey and request that system 100 (i.e., processor 120) transmit the selected survey to the user. Upon receipt of the request, system 100 will then transmit the selected survey to the user. The user completes the survey and returns the survey to system 100 (i.e., processor 120). System 100 then transmits notice to the user that the survey has been properly completed. The user can then search through a plurality of commodities that the user may desire to acquire. The user then transmits a request to system 100 (i.e., processor 120) that the user desires to acquire a particular commodity. Upon receipt of the request, system 100 will then transmit the particular commodity or otherwise provide the particular commodity to the user.

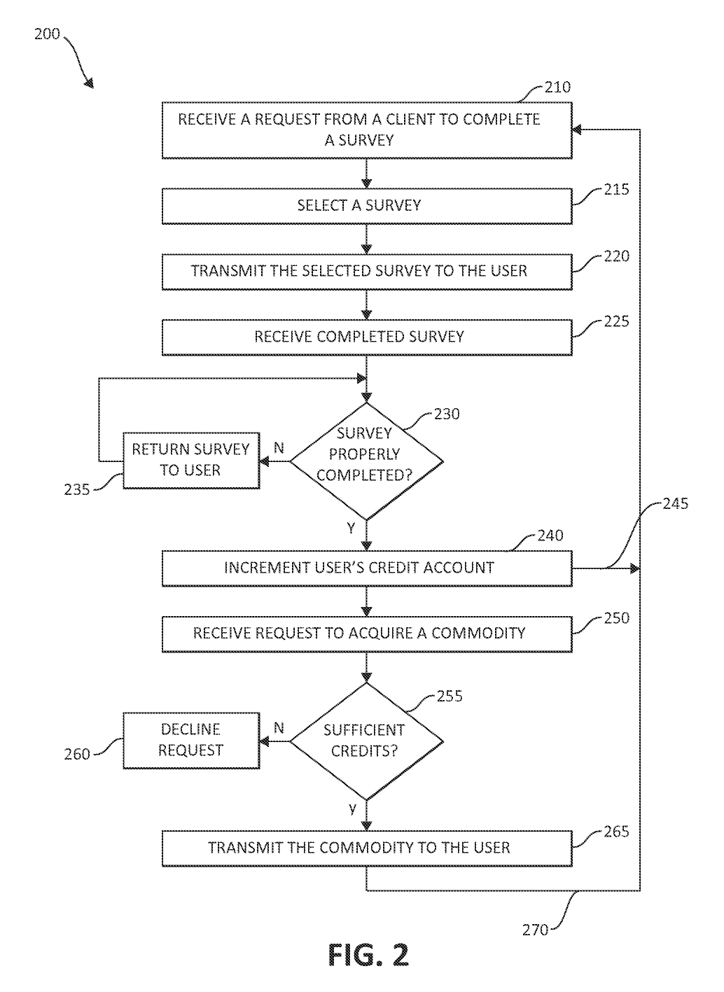

With reference to FIG. 2, FIG. 2 is a flow diagram of one embodiment of a method 200 for enabling a client to acquire a commodity via a survey. At least in the illustrated embodiment, method 200 begins by receiving a request from a user, via a client (e.g., client 50) to complete a survey (block 210). In various embodiments, the client may be a mobile computing device, a desktop computing device, a laptop or notebook computing device, a netbook computing device, a telephony device (e.g. a cellular telephone, a smart phone, etc.), an MP3 player, a computing tablet, a television, and/or the like computing device.

After the request is received, method 200 includes selecting a survey to transmit to the client (block 215). In one embodiment, the survey is randomly selected. In another embodiment, the survey is selected based one or more characteristics of the user, as discussed above with reference to FIG. 1. In yet another embodiment, the user may select the survey, which selection is included with the request to complete the survey.

The selected survey is then transmitted to the client so that the user is able to complete the survey (block 220). Method 200 further includes receiving the completed survey from the client (block 225) and determining if the survey is properly completed (block 230).

If the survey is not properly completed, method 200 includes returning the survey to the user (via the client) so that the user can properly complete the survey (block 235). The survey may not be properly completed if, for example, not all of the questions are answered, there is more than one answer for a particular question, and the like deficiencies.

If the survey was properly completed, method 200 includes incrementing the user's credit account by an appropriate amount (block 240). In various embodiments, each survey may be worth the same number of credits or a differing number of credits. In embodiments including differing amounts of credits, the number of credits may be determined by the length, complexity, and/or other predetermined characteristics of the surveys.

The user may subsequently decide that he/she desires to accumulate more credits by completing more surveys (block 245). From here, method 200 returns to block 210 to further receive a request from the user to complete a survey.

At some point in time, the user may desire to acquire one or more commodities. When this occurs, method 200 includes receiving a request from the user to acquire the one or more commodities (block 250). Method further includes determining if the user has sufficient credits in his/her credit account to acquire the one or more commodities (block 255).

If the user includes an insufficient number of credits in his/her credit account, method 200 includes declining the request to acquire the commodity (block 260). If the user includes a sufficient number of credits in his/her credit account, method 200 includes decrementing the user's credit account the appropriate number of credits and transmitting the commodity to the user (block 265). The user may then decide that he/she desires to accumulate more credits by completing more surveys (block 270). From here, method 200 returns to block 210 to further receive a request from the user to complete a survey.

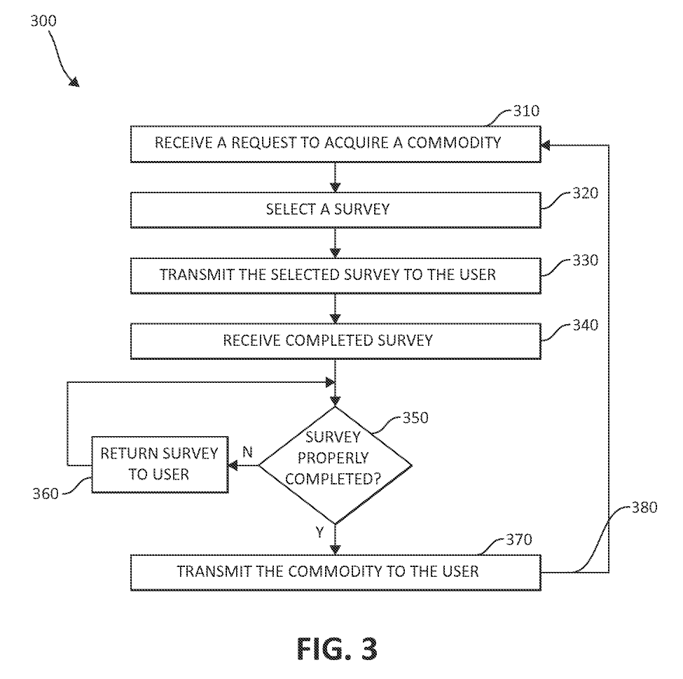

With reference now to FIG. 3, FIG. 3 is a block diagram of another embodiment of a method 300 for enabling a client to acquire a commodity via a survey. At least in the illustrated embodiment, method 300 begins by receiving a request from a user, via a client (e.g., client 50) to acquire a commodity (block 310). In various embodiments, the client may be a mobile computing device, a desktop computing device, a laptop or notebook computing device, a netbook computing device, a telephony device (e.g. a cellular telephone, a smart phone, etc.), an MP3 player, a computing tablet, a television, and/or the like computing device.

After the request is received, method 300 includes selecting a survey to transmit to the client (block 320). In one embodiment, the survey is randomly selected. In another embodiment, the survey is selected based one or more characteristics of the user, as discussed above with reference to FIG. 1. In yet another embodiment, the survey is related to the commodity desired by the user, as discuss above with reference to FIG. 1.

The selected survey is then transmitted to the client so that the user is able to complete the survey (block 330). Method 300 further includes receiving the completed survey from the client (block 340) and determining if the survey is properly completed (block 350).

If the survey is not properly completed, method 300 includes returning the survey to the user (via the client) so that the user can properly complete the survey (block 360). The survey may not be properly completed if, for example, not all of the questions are answered, there is more than one answer for a particular question, and the like deficiencies.

If the survey was properly completed, method 300 includes transmitting the commodity to the user (block 370). The user may then decide that he/she desires one or more additional commodities by completing more surveys (block 380). From here, method 300 returns to block 310 to further receive a request from the user to acquire a commodity.

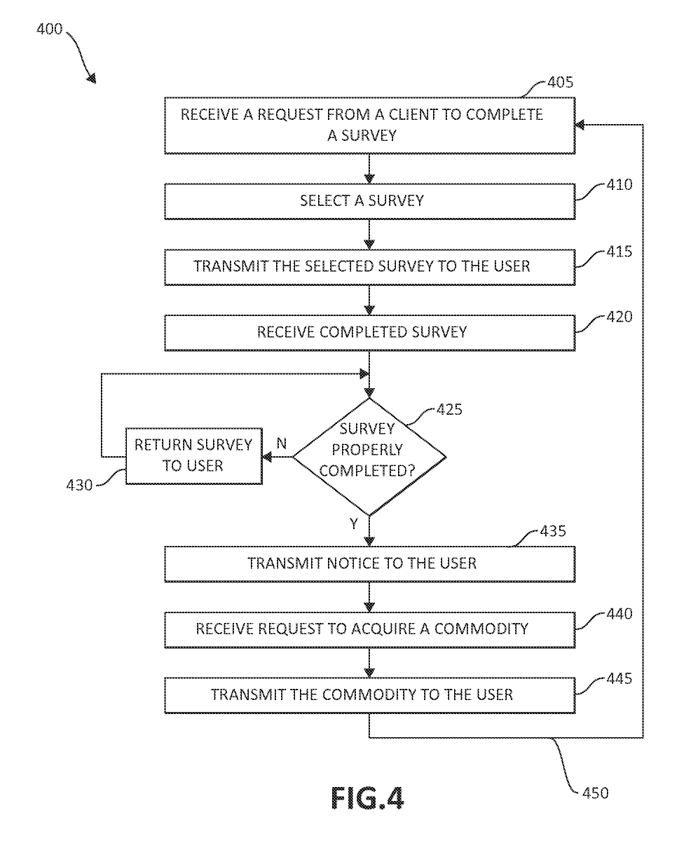

Referring now to FIG. 4, FIG. 4 is a block diagram of yet another embodiment of a method 400 for enabling a client to acquire a commodity via a survey. At least in the illustrated embodiment, method 400 begins by receiving a request from a user, via a client (e.g., client 50) to complete a survey (block 405). In various embodiments, the client may be a mobile computing device, a desktop computing device, a laptop or notebook computing device, a netbook computing device, a telephony device (e.g. a cellular telephone, a smart phone, etc.), an MP3 player, a computing tablet, a television, and/or the like computing device.

After the request is received, method 400 includes selecting a survey to transmit to the client (block 410). In one embodiment, the survey is randomly selected. In another embodiment, the survey is selected based one or more characteristics of the user, as discussed above with reference to FIG. 1.

The selected survey is then transmitted to the client so that the user is able to complete the survey (block 415). Method 400 further includes receiving the completed survey from the client (block 420) and determining if the survey is properly completed (block 425).

If the survey is not properly completed, method 400 includes returning the survey to the user (via the client) so that the user can properly complete the survey (block 430). The survey may not be properly completed if, for example, not all of the questions are answered, there is more than one answer for a particular question, and the like deficiencies.

If the survey was properly completed, method 400 includes notifying the user that the survey was properly completed (block 435). Method 400 further includes receiving, after the notice is transmitted, receiving a request from the user, via the client, to acquire a commodity (block 440). Method 400 further comprises transmitting the commodity to the user (block 445). The user may then decide that he/she desires one or more additional commodities by completing more surveys (block 450). From here, method 400 returns to block 410 to further receive a request from the user to acquire a commodity.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

As will be appreciated by one of ordinary skill in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer-readable medium(s) having computer readable program code embodied thereon.

Any combination of one or more computer-readable medium(s) may be utilized. The computer-readable medium may be a computer-readable signal medium or a computer-readable storage medium. A computer readable storage medium may be, for example, but not limited to, an electronic, magnetic, optical, crystal, polymer, electromagnetic, infrared, or semiconductor system, apparatus, or device, or any suitable combination of the foregoing. Examples (a non-exhaustive list) of computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program or data for use by or in connection with an instruction execution system, apparatus, or device.

Program code embodied on a computer-readable medium may be transmitted using any appropriate medium, including but not limited to wireless, wired, optical fiber cable, radio frequency (RF), etc., or any suitable combination of the foregoing. Computer program code for carrying out operations for aspects of the present invention may be written in any static language, such as the “C” programming language or similar programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, or communication system, including, but not limited to, a local area network (LAN) or a wide area network (WAN), Converged Network, or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the above figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While one or more embodiments of the present invention have been illustrated in detail, one of ordinary skill in the art will appreciate that modifications and adaptations to those embodiments may be made without departing from the scope of the present invention as set forth in the following claims.

1. A system, comprising:
a processor; and
memory coupled to the processor, the memory configured to store instructions that, when executed by the processor, cause the processor to:
provide a survey to a client,
receive the survey completed by the client, and
enable the client to utilize completion of the survey to acquire a commodity.

2. The system of claim 1, wherein:
the commodity is one of a data file, a music file, a game file, a digital file, and an application file for downloading to one of a computing device, a smart phone, an MP3 player, and a computing tablet; and
when enabling the client to utilize completion of the survey to acquire the commodity, the processor is configured to:
determine an amount of credits to add to the client account based on a type of the survey,
add the amount of credits to the client account if the survey was completed, and
enable the client to utilize the credits to acquire the commodity.

3. The system of claim 2, wherein the processor, when enabling the client to utilize the credits to acquire the commodity, is further configured to:
receive a request from the client to acquire the commodity using credits in the client account;
determine a value in credits for the commodity;
provide the commodity to the client if the client account includes more than or equal to the value;
subtract credits equal to the value from the client account if the commodity was provided to the client; and
decline to provide the commodity to the client if the client account includes less than the value.

4. The system of claim 1, wherein the processor is further configured to:
receive a request from the client to acquire the commodity prior to providing the survey; and
provide a type of the survey based on a type of the commodity, wherein:
the type of the commodity is one of a data file, a music file, a game file, and an application file for acquire to one of a computing device, a smart phone, an MP3 player, and a computing tablet, and
the type of the survey is based on at least one of a client profile, a client preference, a complexity of the survey, and a length of the survey.

5. The system of claim 1, wherein when providing the survey the processor is configured to provide a type of the survey based on at least one of a client profile, a client preference, a complexity of the survey, and a length of the survey.

6. The system of claim 1, the processor further configured to receive a request from the client to complete a survey, wherein when providing the survey the processor is configured to:
provide a plurality of surveys to the client in response to the request, and
provide the plurality of surveys based on at least one of a client profile, a client preference, a complexity of the survey, and a length of the survey.

7. The system of claim 1, wherein the processor is further configured to receive a request from the client to complete a survey, the request received from a mobile device.

8. The system of claim 1, wherein the processor is configured to provide a notification to the user that a survey is available prior to providing the survey, wherein:
the notification is one of a push notification, a social media message, a text message, an email message, and an instant message, and
a type of the survey is based on one of a client profile and a client preference.

9. A method, comprising:
providing, by a processor, a survey to a client;
receiving the survey completed by the client; and
enabling the client to utilize completion of the survey to acquire a commodity.

10. The method of claim 9, wherein:
the commodity is one of a data file, a music file, a game file, a digital file, and an application file for downloading to one of a computing device, a smart phone, an MP3 player, and a computing tablet; and
enabling the client to utilize completion of the survey to acquire the commodity comprises:
determining an amount of credits to add to the client account based on a type of the survey,
adding the amount of credits to the client account if the survey was completed, and
enabling the client to utilize the credits to acquire the commodity.

11. The method of claim 10, wherein enabling the client to utilize the credits to acquire the commodity further comprises:
receiving a request from the client to acquire the commodity using credits in the client account;
determining a value in credits for the commodity;
providing the commodity to the client if the client account includes more than or equal to the value;
subtracting credits equal to the value from the client account if the commodity was provided to the client; and
declining to provide the commodity to the client if the client account includes less than the value.

12. The method of claim 9, further comprising:
receiving a request from the client to acquire the commodity prior to providing the survey; and
providing a type of the survey based on a type of the commodity, wherein:
the type of the commodity is one of a data file, a music file, a game file, and an application file for acquire to one of a computing device, a smart phone, an MP3 player, and a computing tablet, and
the type of the survey is based on at least one of a client profile, a client preference, a complexity of the survey, and a length of the survey.

13. The method of claim 9, wherein providing the survey comprises providing a type of the survey based on at least one of a client profile, a client preference, and a length of the survey.

14. The method of claim 9, further comprising receiving a request from the client to complete a survey, wherein:
providing the survey comprises providing a plurality of surveys to the client in response to the request, and
providing the plurality of surveys comprises providing the plurality of surveys based on at least one of a client profile, a client preference, a complexity of the survey, and a length of the survey.

15. The method of claim 9, further comprising receiving a request from the client to complete a survey, the request received from a mobile device.

16. The method of claim 9, further comprising providing a notification to the user that a survey is available prior to providing the survey, wherein:
the notification is one of a push notification, a social media message, a text message, an email message, and an instant message, and
a type of the survey is based on one of a client profile and a client preference.

17. A computer program product comprising a computer-readable medium configured to store instructions that, when executed by a processor, cause the processor to perform a method, the computer program product comprising:
computer code for providing, by the processor, a survey to a client;
computer code for receiving the survey completed by the client; and
computer code for enabling the client to utilize completion of the survey to acquire a commodity.

18. The computer program product of claim 17, wherein:
the commodity is one of a data file, a music file, a game file, a digital file, and an application file for downloading to one of a computing device, a smart phone, an MP3 player, and a computing tablet; and
the computer code for enabling the client to utilize completion of the survey to acquire the commodity comprises:
computer code for determining an amount of credits to add to the client account based on a type of the survey,
computer code for adding the amount of credits to the client account if the survey was completed, and
computer code for enabling the client to utilize the credits to acquire the commodity.

19. The computer program product of claim 18, wherein the computer code for enabling the client to utilize the credits to acquire the commodity further comprises:
computer code for receiving a request from the client to acquire the commodity using credits in the client account;
computer code for determining a value in credits for the commodity;
computer code for providing the commodity to the client if the client account includes more than or equal to the value;
computer code for subtracting credits equal to the value from the client account if the commodity was provided to the client; and
computer code for declining to provide the commodity to the client if the client account includes less than the value.

20. The computer program product of claim 17, further comprising:
computer code for receiving a request from the client to acquire the commodity prior to providing the survey; and
computer code for providing a type of the survey based on a type of the commodity, wherein:
the type of the commodity is one of a data file, a music file, a game file, and an application file for acquire to one of a computing device, a smart phone, an MP3 player, and a computing tablet, and
the type of the survey is based on at least one of a client profile, and client preference, a complexity of the survey, and a length of the survey.

21. The computer program product of claim 17, wherein the computer code for providing the survey comprises computer code for providing a type of the survey based on at least one of a client profile, a client preference, a complexity of the survey, and a length of the survey.

22. The computer program product of claim 17, further comprising computer code for receiving a request from the client to complete a survey, wherein:
the computer code for providing the survey comprises computer code for providing a plurality of surveys to the client in response to the request, and
the computer code for providing the plurality of surveys comprises computer code for providing the plurality of surveys based on at least one of a client profile and client preferences.

23. The computer program product of claim 17, further comprising computer code for receiving a request from the client to complete a survey, the request received from a mobile device.

24. The computer program product of claim 17, further comprising computer code for providing a notification to the user that a survey is available prior to providing the survey, wherein:
the notification is one of a push notification, a social media message, a text message, an email message, and an instant message, and
a type of the survey is based on one of a client profile and a client preference.
